(19) United States
(12) Patent Application Publication
(10) Pub. No.: US 2026/0227754 A1
(43) Pub. Date: Aug. 6, 2026

(54) Irrigation Software Interface

(71) Applicant: The Toro Company, Bloomington, MN (US)

(72) Inventors: John Dalman, Bloomington, MN (US); Adam Munir, Bloomington, MN (US)

(73) Assignee: The Toro Company, Bloomington, MN (US)

(21) Appl. No.: 19/465,874

(22) Filed: Jan. 30, 2026

Related U.S. Application Data
(60) Provisional application No. 63/752,418, filed on Jan. 31, 2025.

(51) Int. Cl. G05B 19/042

(52) U.S. Cl. CPC G05B 19/042; G05B 2219/26

(57) ABSTRACT

An irrigation control system includes a central irrigation controller configured to control a plurality of irrigation sprinklers and display an interface representing an irrigation site. The interface displays watering area elements corresponding to watering areas of individual sprinklers. For each sprinkler, a representative soil moisture value is calculated from a plurality of soil moisture measurements obtained at geographic locations within the watering area of that sprinkler. The representative soil moisture value may be displayed numerically and/or by color coding and may be compared to a user-specified target to determine a delta soil moisture value and a suggested irrigation adjustment. Tabular and graphical displays enable sprinkler-specific monitoring and control.

### RELATED APPLICATIONS

This application claims benefit of and priority to U.S. Provisional Application Ser. No. 63/752,418 filed Jan. 31, 2025 entitled Irrigation Software Interface, which is hereby incorporated herein by reference in its entirety.

### BACKGROUND

Computerized irrigation systems for implementing automatic turf or landscape watering are presently in widespread use. Typical systems include a plurality of valves and a plurality of sprinklers in fluid and electrical communication with a water source and a computerized central controller, which controls both the opening and the closing of the water valves in accordance with a predetermined schedule to, in turn, allow water to flow from the water source to the sprinklers, and issue therefrom, at appropriate times.

In some computerized irrigation systems, the central controller may implement complex irrigation schedules, provide different settings for each of a plurality of different sprinkler groups, monitor water consumption, monitor water flow rate, monitor water pressure, monitor weather and soil moisture data via sensors, and identify electrical or mechanical issues, among other capabilities. In order to provide this functionality, some central irrigation controllers may include irrigation specific software executed on, for example, a local server, a desktop computer, and/or an electronic tablet/phone.

### SUMMARY

In some aspects, the techniques described herein relate to a system for watering an irrigation site, the system including: a central irrigation controller including a processing device and a memory device storing computer readable instructions executable by the processing device to cause the processing device to: control a plurality of irrigation sprinklers; display an interface including: a graphical geographic map representing the irrigation site; and, watering area elements that each correspond to a respective geographical watering area of a corresponding one of a plurality of irrigation sprinklers located at the irrigation site; wherein each of the watering area elements indicate a soil moisture metric based on a representative soil moisture value calculated from a plurality of soil moisture measurements at geographic coordinate locations located within the respective geographical watering area of only the corresponding one of the plurality of irrigation sprinklers.

In some aspects, the techniques described herein relate to a system, wherein the watering area elements indicate the soil moisture metric by displaying a numeric value in one or more of the watering area elements, by changing or displaying a color that corresponds to the soil moisture metric, or by both displaying a numeric value that corresponds to the soil moisture metric and changing or displaying a color that corresponds to the soil moisture metric.

In some aspects, the techniques described herein relate to a system, wherein the soil moisture metric is displayed in numeric form.

In some aspects, the techniques described herein relate to a system, wherein the numeric form is the representative soil moisture value.

In some aspects, the techniques described herein relate to a system, wherein the representative soil moisture value is displayed as an average volumetric water content.

In some aspects, the techniques described herein relate to a system, wherein the numeric form is a delta soil moisture value calculated by a difference between a target soil moisture value for a single sprinkler and a single representative value of the single sprinkler.

In some aspects, the techniques described herein relate to a system, wherein the representative soil moisture value is calculated by generating an average or weighted average of the plurality of soil moisture measurements.

In some aspects, the techniques described herein relate to a system, wherein the watering area elements are circular in shape.

In some aspects, the techniques described herein relate to a system, wherein the watering area elements indicate the soil moisture metric by changing or displaying a color that corresponds to the soil moisture metric.

In some aspects, the techniques described herein relate to a system, wherein soil moisture metric is the representative soil moisture value.

In some aspects, the techniques described herein relate to a system, wherein the soil moisture metric is a delta soil moisture value calculated by a difference between a target soil moisture value for a single sprinkler and a single representative value of the single sprinkler.

In some aspects, the techniques described herein relate to a system, wherein the watering area elements display numerical values of the representative soil moisture value.

In some aspects, the techniques described herein relate to a system, wherein the interface further includes a table displaying a plurality of sprinkler identifiers that each correspond to one of the plurality of sprinklers and the soil moisture metric of each of the plurality of sprinklers.

In some aspects, the techniques described herein relate to a system, wherein the soil moisture metric is the representative soil moisture value or a delta soil moisture value calculated by a difference between a target soil moisture value for a single sprinkler and the representative value of the corresponding sprinkler.

In some aspects, the techniques described herein relate to a system, wherein the table further displays a suggested adjustment value for each of the each of the sprinkler identifiers, wherein the suggested adjustment value is calculated by determining a difference between the representative soil moisture value and a user-defined target value.

In some aspects, the techniques described herein relate to a system, wherein the interface further includes a graph or chart area displaying plurality of the representative soil moisture values for one of the plurality of irrigation sprinklers from different dates.

In some aspects, the techniques described herein relate to a method for watering an irrigation site, including: executing irrigation software on a central irrigation controller configured to control a plurality of irrigation sprinklers; displaying an interface of the irrigation software with the central irrigation controller, the interface including: a graphical geographic map representing the irrigation site; and, watering area elements that each correspond to a respective geographical watering area of a corresponding one of a plurality of irrigation sprinklers located at the irrigation site; wherein each of the watering area elements indicate a soil moisture metric based on a representative soil moisture value calculated from a plurality of soil moisture measurements at geographic coordinate locations located within the respective geographical watering area of only the corresponding one of the plurality of irrigation sprinklers.

In some aspects, the techniques described herein relate to a method, wherein the watering area elements indicate the soil moisture metric by displaying a numeric value in one or more of the watering area elements, by changing or displaying a color that corresponds to the soil moisture metric, or by both displaying a numeric value that corresponds to the soil moisture metric and changing or displaying a color that corresponds to the soil moisture metric.

In some aspects, the techniques described herein relate to a method, wherein the representative soil moisture value is calculated by generating an average or weighted average of the plurality of soil moisture measurements.

In some aspects, the techniques described herein relate to irrigation software stored on a non-transitory machine-readable medium, the irrigation software including computer-executable instructions which, when executed by a processing device of a central irrigation controller, cause the processing device to: control a plurality of irrigation sprinklers; display an interface including a graphical geographic map representing the irrigation site and watering area elements that each correspond to a respective geographical watering area of a corresponding one of a plurality of irrigation sprinklers located at an irrigation site; compute for each of the plurality of irrigation sprinklers, a soil moisture metric based on a representative soil moisture value calculated from a plurality of soil moisture measurements at geographic coordinate locations located within the respective geographical watering area of only the corresponding one of the plurality of irrigation sprinklers; and, cause each of the watering area elements to indicate the soil moisture metric associated with the corresponding irrigation sprinkler.

In some aspects, the techniques described herein relate to a system for adjusting irrigation at an irrigation site, the system including: a central irrigation controller including a processing device and a memory device storing computer-readable instructions executable by the processing device to cause the processing device to: control a plurality of irrigation sprinklers; display an interface identifying a plurality of the irrigation sprinklers; receive a selection of multiple irrigation sprinklers from the plurality of irrigation sprinklers; and in response to a bulk adjustment input, replace or shift an irrigation parameter for each of the selected irrigation sprinklers by replacing or shifting a target watering amount for each of the selected irrigation sprinklers.

In some aspects, the techniques described herein relate to a system for monitoring irrigation at an irrigation site, the system including: a central irrigation controller including a processing device and a memory device storing computer-readable instructions executable by the processing device to cause the processing device to: control a plurality of irrigation sprinklers; determine, for each of the plurality of irrigation sprinklers, a measurement value associated with a watering area of that irrigation sprinkler; display an interface identifying the plurality of irrigation sprinklers; receive a filter criterion specifying whether the measurement value is above or below a target irrigation value; and in response to the filter criterion, selectively display or identify a subset of the plurality of irrigation sprinklers whose measurement values satisfy the filter criterion.

In some aspects, the techniques described herein relate to a system for adjusting irrigation at an irrigation site, the system including: a central irrigation controller including a processing device and a memory device storing computer-readable instructions executable by the processing device to cause the processing device to: control a plurality of irrigation sprinklers based on one or more irrigation parameters; display a configuration interface including one or more input elements for defining crop coefficient settings associated with the irrigation site; receive, via the configuration interface, user input specifying at least one crop coefficient parameter; and apply the at least one crop coefficient parameter to modify calculation or application of the one or more irrigation parameters used to control the plurality of irrigation sprinklers.

### BRIEF DESCRIPTION OF THE DRAWINGS

FIG. 1 is a schematic diagram of an example irrigation system including a central irrigation controller and a plurality of sprinklers.

FIG. 2 is a block diagram illustrating an example central irrigation controller in communication with a mobile device, a remote server, and a remote storage device.

FIG. 3 is a schematic view of an irrigation site showing geographic locations of soil moisture measurements within a watering area of a sprinkler.

FIG. 4 is an example irrigation software interface displaying a geographic map with watering area elements and representative soil moisture values.

FIG. 5 is a magnified view of a portion of the interface of FIG. 4.

FIG. 6 is an example irrigation software interface displaying watering area elements using color coding to represent representative soil moisture values.

FIG. 7 is an example irrigation software interface displaying delta soil moisture values.

FIG. 8 is an example irrigation software interface displaying tabular and graphical data for an individual sprinkler.

FIGS. 9, 10, and 11 are example mobile device interfaces for monitoring and adjusting irrigation.

FIG. 12 is an example bulk adjustment interface for adjusting irrigation parameters for a plurality of selected sprinklers.

FIG. 13 is an example filter interface for identifying sprinklers with soil moisture values above or below target values.

FIG. 14 is an example crop coefficient and evapotranspiration settings interface.

### DETAILED DESCRIPTION

It will be appreciated by persons skilled in the art that the present disclosure is not limited to what has been particularly shown and described herein. A variety of modifications and variations are possible in view of the teachings herein without departing their scope, spirit, or intent.

While different examples may be described in this specification, it is specifically contemplated that any of the features from the different examples can be used and brought together in any combination. In other words, the features of different examples can be mixed and matched with each other. Hence, while every permutation of features from different examples may not be explicitly shown or described, it is the intention of this disclosure to cover any such combinations, especially as may be appreciated by one of skill in the art.

The terminology used in this disclosure should be interpreted in a permissive manner and is not intended to be limiting. In the drawings, like numbers refer to like elements. Unless otherwise noted, all of the accompanying drawings are not to scale. Unless otherwise noted, the term “about” is defined to mean plus-or-minus 5% of a stated value.

Numerical ranges discussed in this specification should be interpreted as both inclusive numerical ranges and as covering/disclosing a plurality of numbers within the ranges. Specifically, a range should be considered to recite numbers that increment by two decimal places (hundredths) for the purposes of support in the claims (e.g., 0.01, 0.02, 0.03, etc.). Any of these incremented numbers from a range should be understood to have significance and importance in the context of the present specification.

The calculations described herein are used to automatically modify operation of physical irrigation components, including valves, sprinklers, and watering schedules, thereby producing a tangible effect on water delivery at the irrigation site.

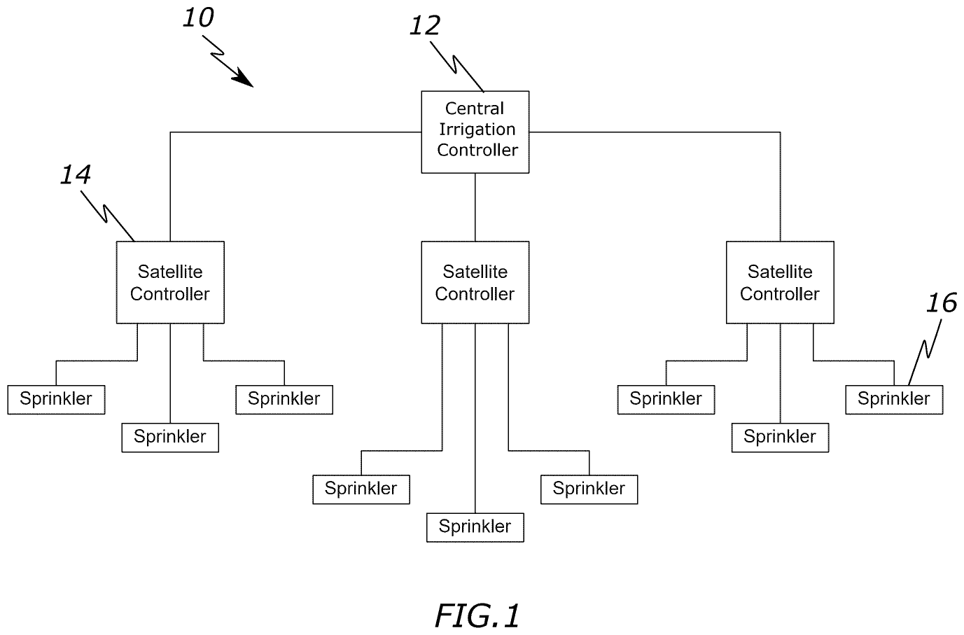

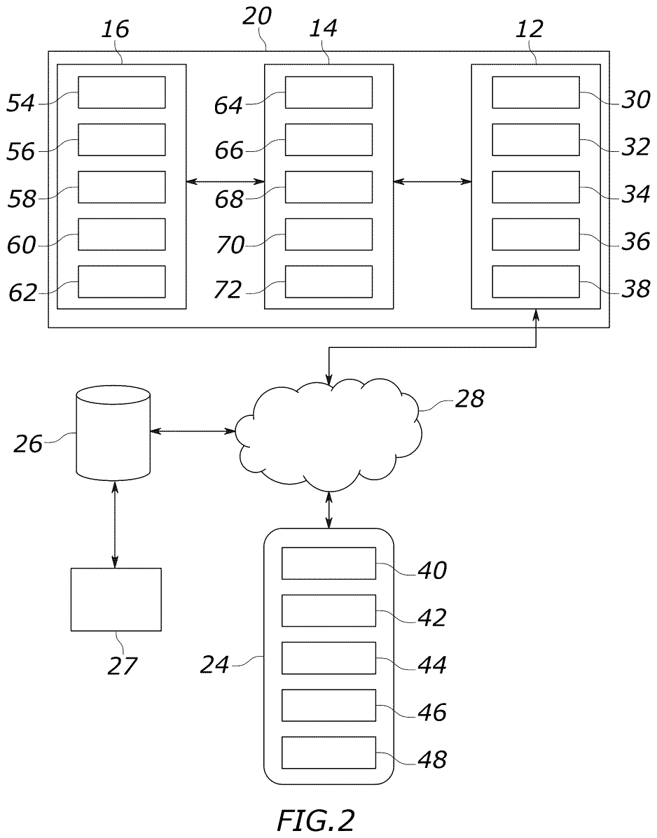

FIG. 1 illustrates a schematic diagram of an irrigation system 10 in accordance with at least one example of the present disclosure. The irrigation system 10 may include a central irrigation controller 12, which may be a local computer or server including any of the various aspects or features of the central irrigation controller 12 described with respect to FIG. 2 below. In some examples, the central irrigation controller 12 may be communicatively connected (e.g., via various wired or wireless means) to a plurality of satellite controllers or two-wire communication gateways 14. Each satellite controller or gateway of the plurality of satellite controllers or gateways 14 may be connected to a valve in one or more of a plurality of sprinklers 16 of the irrigation system 10.

The central irrigation controller 12 may wirelessly communicate watering or irrigation schedule information to an appropriate satellite controller or gateway of the plurality of satellite controllers or gateways 14 via various techniques known in the art. In turn, the satellite controller or gateways 14 may cause the plurality of sprinklers 16 to water physical terrain proximal thereto according to the watering or irrigation schedule of the central irrigation controller 12. In this way, the plurality of satellite controllers 14 may determine when each of the plurality of sprinklers 16 distributes water to an area of physical terrain located proximally thereto.

Typically, satellite controllers will selectively supply power to a valve within a sprinkler or a valve supplying a water to a sprinkler. Hence, the valve may be opened or closed when powered or unpowered.

Gateways typically supply current over two wires and then modify aspects of the current to transmit data. Decoders are typically connected to valves within sprinklers 16 or to nearby valves that supply water to one or more sprinklers 16. When these decoders receive a command to water, they open the valve they are connected to, causing water to flow from one or more sprinklers 16.

The central irrigation controller 12 may include irrigation control software that is executable by a processor thereof, to enable the central irrigation controller 12 to implement various methods and techniques in accordance with this disclosure. In some examples, the central irrigation controller 12 may be a local computer storing data (e.g., local to the irrigation site), including executable irrigation control software, in a locally attached storage device (e.g., in an attached hard drive). In some examples, the irrigation control software, or any software described herein, may be executed, and stored on a storage device on a remote server. In such an example, any network connected device, such as a remote computer, tablet, phone, or similar device, may display an interface of the central irrigation controller 12 via a webpage over the internet or the network 28, as well as a display and input mechanism (e.g., keyboard/mouse) directly connected to the central irrigation controller 12. In some examples, processes, methods, algorithms, and similar aspects of the central irrigation controller 12 may be partially executed on a local computer (e.g., local to the irrigation site) and partially executed on a remove server (i.e., remote from the irrigation site).

FIG. 2 illustrates an example irrigation system 20 including a central irrigation controller 12 in communication with a mobile device 24, a remote storage device 26, and a remote server 27, over a network 28. The central irrigation controller 12 may be, or may not be component of, the central irrigation controller 12 (FIG. 1). The central irrigation controller 12 and the mobile device 24 may each enable a user to perform any of the methods or techniques of the present disclosure. Each of the central irrigation controller 12 or the mobile device 24 may operate as an independent device or may be networked to other systems or devices. In a networked configuration, the central irrigation controller 12 may operate as a server machine, a client machine, or both, such as in server-client network environments. In one example, the central irrigation controller 12 may act as a peer machine in a peer-to-peer (P2P), or any distributed network environment.

The central irrigation controller 12 may be realized in the form of a personal computer (“PC”), an electronic tablet, a personal digital assistant (PDA), a set-top box (STB), a network router, a web appliance, a switch or bridge, or any other device or system capable of executing instructions that cause or specify actions to be taken by that device or system. Further, while only a single box representing the central irrigation controller 12 is illustrated, the term “central controller” or “central computer” is to be taken as including any collection of devices that may individually, or jointly, execute one or more sets of instructions to perform any of the methods or techniques of the present disclosure, such as cloud computing, software as a service (“SaaS”), other computer cluster configurations.

The mobile device 24 may be a mobile phone (e.g., a smartphone), an electronic tablet, a personal digital assistant (PDA), or any mobile device or computing system capable of executing instructions that cause or specify actions to be taken by the mobile device. The central irrigation controller 12 may include, among others, a processor 30, a memory 32, an input/output system (“I/O”) 34, a global positioning system 36 (“GPS”), and a communication module 38. Similarly, the mobile device 24 may include, among others, a processor 40, a memory 42, an input/output system (“I/O”) 44, a global positioning system 46 (“GPS”), and a communication module 48.

The processor 30 and the processor 40 may, for example, each be representative of a central processing unit (“CPU”), a graphics processing unit (“GPU”), a hardware processor core, or a combination thereof. The memory 32 and the memory 42 may be representative of a main memory and a static memory, some or all of which can communicate with each other via an interlink (e.g., bus). The memory 32 and the memory 42 may further be representative of a storage device (e.g., a drive unit) of the central irrigation controller 12 and the mobile device 24, respectively, including a machine readable medium on which the operating system and the irrigation controller software (e.g., one or more sets of data structures or instructions embodying or utilized by any one or more of the method, techniques, or functions of the present disclosure) of the present disclosure is stored.

The irrigation control software of the present disclosure may also reside, completely or partially, within the main memory or the static memory of the memory 32, within the main memory of the static memory of the memory 42, or within the processor 30 or the processor 40, during execution thereof by the central irrigation controller 12 or the mobile device 24, respectively. In further examples, any combination of the processor 30 or the processor 40, the main memory or the static memory of the central irrigation controller 12 or the mobile device 24, or the storage device of the central irrigation controller 12 or the mobile device 24 may constitute machine-readable media. In some examples, the memory 32 and the memory 42 may also include cloud-based memory storage. While the memory 32 and the memory 42, and by extension, the machine readable medium thereof, are each illustrated as a single boxes in FIG. 2, it is to be appreciated that the term “machine readable medium” as used herein also includes a single medium or multiple mediums or media (e.g., a centralized or distributed database, or any associated caches or servers) configured to store the irrigation control software of the present disclosure.

Additionally, as used in the present document, the term “machine readable medium” is to be taken as including or encompassing any medium that is capable of storing, encoding, or carrying instructions (e.g., software) for execution by the central irrigation controller 12 or the mobile device 24 to perform any one or more of the method or techniques of the present disclosure, or that is otherwise capable of storing, encoding or carrying data structures used by, or associated with, such instructions. Some non-limiting machine-readable medium examples may include, among others, solid-state memories, or optical and magnetic media.

The I/O system 34 and the I/O system 44 may include, among others, a display unit (e.g., a screen), an alphanumeric input device (e.g., a keyboard), and a user interface (UI) navigation device (e.g., a mouse, touchpad, or touch screen). In some examples, the display unit, the alphanumeric input device, and the UI navigation device can be a touch screen display. The GPS system 36 and the GPS system 46 may each be a GPS sensor or receiver, such as locatable by a global position system (GPS) based on GPS satellite signals as well known in the art. Alternatively, geospatial positioning of the mobile device 24 or the central irrigation controller 12 may be determined by triangulating a position thereof based on the signal strengths of at least two wireless communications transceivers, as described in U.S. Pat. Nos. 6,694,142; 4,926,161; and 6,826,162; the contents each of which are hereby incorporated by reference.

The central irrigation controller 12 or the mobile device 24 may further include a variety of additional features not specifically discussed above, such as, but not limited to, a signal generation device (e.g., a speaker), a camera, a haptic feedback device (e.g., a vibration motor, linear actuator, etc.) and one or more sensors including, for example, a compass, accelerometer, or various other sensors known in the art for mobile devices or personal computers. In some examples, the central irrigation controller 12 or the mobile device 24 may include an output controller, such as a serial (e.g., Universal Serial Bus (USB), parallel, or other wired or wireless (e.g., infrared (IR), near field communication (NFC), etc.) connection to communicate or control one or more peripheral devices (e.g., a printer, card reader, etc.).

The instructions (e.g., the irrigation control software) of the present disclosure may be transmitted or received, over the network 28 using a transmission medium provided by the communication system 48 of the mobile device 24 or the communication system 38 of the central irrigation controller 12. For example, the communication system 34 or the communication system 46 may be representative of a network interface device utilizing any of a number of transfer or communication protocols, such as, but not limited to, frame relay, internet protocol (“IP”), transmission control protocol (TCP), user datagram protocol (UDP), or hypertext transfer protocol (“HTTP). The term “transmission medium” as used in the present document is to encompass any intangible medium that may store, encode or carry instructions for execution by an electronic device or system, and includes digital or analog communications signals or other intangible medium to facilitate communication of software.

Example communication networks represented by the network 28 may include, for example, but not limited to, a packet data network (e.g., the Internet), a wide area network (WAN), a local area network (LAN), a mobile telephone network (e.g., cellular network), or a wireless data network, for example, but not limited to, the Institute of Electrical and Electronics Engineers (“IEEE”) 802.11 family of standards, also known as Wi-Fi®, the IEEE 802.16 family of standards, also known as WiMax®, the IEEE 802.15.4 family of standards, Bluetooth (e.g., Bluetooth Low Energy (BLE), “LoRa”, or “LoRaWAN”, or peer-to-peer (P2P) networks. In further examples, the communication system 36 and the communication system 46 may include one or more physical jacks (e.g., Ethernet, coaxial, or phone jacks) or one or more antennas to connect to the network 28. In some examples, the communication system 38 or the communication system 48 may also include a plurality of antennas to wirelessly communicate using at least one of single-input multiple-output (SIMO), multiple-input multiple-output (MIMO), or multiple-input single-output (MISO) techniques.

The irrigation system 20 may include one or a plurality of sprinklers 16, and in some examples, a satellite controller or gateway 14. Each of the sprinkler 16 or satellite controller/gateway 14 may operate as an independent device or may be networked to other systems or devices. The sprinkler 16 may be, for example, representative of each of the plurality of sprinklers 16 described with reference to FIG. 1 above. Similarly, the satellite controller or gateway 14 may be, for example, representative each of the plurality of satellite controllers or gateways 14 described with reference to FIG. 1 above.

The satellite controller or gateway 14 may generally include some or all of the features or capabilities described with respect to the mobile device 24, such as, but not limited to, a processor 64, a memory 66, an input/output system (“I/O”) 68, a global positioning system 70 (“GPS”), and a communication module 72 each of which may be similar or different to the processor 40, the memory 42, the input/output system (“I/O”) 44, the global positioning system 46 (“GPS”), and the communication module 48. In some examples, the communication module 72 may be different from the communication module 48, at least in that it may include terminals that selectively supply power to water valve that is connected to multiple sprinklers, or to a water valve of each sprinkler of the plurality of sprinklers 16 (FIG. 1).

In such examples, the communication module 72 may support command protocols of more conventional electric solenoid interface (e.g., selectively applying 24 VAC (e.g., alternating current) at 1 amp), as well as more complicated communications protocols that may support two-wire physical power line communication for operational control of the sprinkler 16. In some examples, the communication module 72 may include or function as a gateway or a protocol converter to connect two networks (e.g., the central irrigation controller 12 and each sprinkler 16) that may work upon different networking models or communication protocols. Hence, a “satellite controller” may include a gateway component within it and/or traditional protocols of selectively applying power to specific sprinklers/valves.

In some examples, the sprinkler 16 may include a solenoid valve that opens or closes when power when power is supplied to it, causing water to spray from a nozzle of the sprinkler.

In some examples, the sprinkler 16 may include a two-wire decoder that receives power and communications from two wires connected between it and a gateway. When an irrigation command is received, the decoder causes a solenoid valve within the sprinkler to open and therefore water to spray from a nozzle of the sprinkler. Two-wire decoders typically include a processor or microcontroller, as well as memory to receive communications and cause irrigation from the sprinkler 16.

In some more complicated examples, the sprinkler 16 may include a microprocessor 54 that controls various electrical components of the sprinkler 16. For example, such electrical components may include a stepper motor component 56 which controls the rotation of a nozzle base (the portion of the sprinkler 16 containing a sprinkler nozzle), a solenoid driver component 58 that may actuate a valve inside the sprinkler 16 to begin or end irrigation, a sensor component 60 that may sense the nozzle position (rotational position and horizontal position), and a communication component 62 that may send and receive data between the satellite controller 14, other sprinklers, or in some examples, the central irrigation controller 12. In some examples, the microprocessor 54 and the communication component 62 may be components of a two-wire decoder for accepting power and communication signals, which may selectively power to the solenoid driver component 58 to cause the valve inside the sprinkler 16 to open or close.

In the operation of some examples of the irrigation system 20, command signals from either the central irrigation controller 12 or the satellite controller/gateway 14 are addressed to an individual sprinkler, such as the sprinkler 16 of the plurality of sprinklers 16 (FIG. 1) and received by the communication component 62 thereof. The microprocessor 54 may then process the command signals and actuate an appropriate component of the sprinkler 16. For example, a watering command signal delivered from the central irrigation controller 12 may cause the microprocessor 54 to activate the solenoid driver component 58 to open an internal water valve of the sprinkler 16, causing the nozzle base to rise from the sprinkler body and water to exit the nozzle. In some such examples, a watering arc may be manually set or otherwise adjusted by a user. In other examples, the microprocessor 54 may send watering arc control data to the stepper motor component 56 to determine a specific arc and rotation speed that the stepper motor should move the nozzle through.

The microprocessor 54 may also simultaneously interrogate the sensor component 60 for data on the position of the nozzle base (e.g., the vertical position, the rotation position, or the rotational speed). Thus, the sprinkler 16 may execute received watering or irrigation signal commands that are sent to it by the central irrigation controller 12, such as via the satellite control 14, or any other device in communication with the satellite controller 14 or directly with the sprinkler 16 via the network 28, such as the mobile device 24. Optionally, the sprinkler 16 or the satellite controller 14 may transmit sensor feedback back to the central irrigation controller 12 or the mobile device 24 (e.g., did the sprinkler popup, did the sprinkler rotate, how long did the sprinkler run, how many cycles or rotations through the desired arc did the sprinkler make, what was the water pressure at the sprinkler, what was the flow at the sprinkler, etc.).

The remote storage device 26 may be representative of any remote storage device or system configured for use by authorized users of a business, such as a golf course. In some examples, the remote storage device 26 may be a cloud database deployed, delivered, and accessed via cloud computing (e.g., the internet). The remote storage device 26 may organize and store structured, unstructured, and semi-structured data in a manner similar to a physical database. The remote storage device 26 may be, for example, but not limited to, a managed database-as-a-service (DBaaS) or deployed on a cloud-based virtual machine (VM). The remote storage device 26 may, in some examples, constitute a machine readable medium on which the irrigation control software of the present disclosure (e.g., one or more sets of data structures or instructions utilized by any device embodied by any method or technique herein) is stored.

In one example, the remote storage device 26 may include any irrigation control software executable by a processor of the remote server 27, as well as a database containing data (e.g., software settings, irrigation site settings, irrigation data, and similar data) directly connected to the remote server 27. The remote storage device 26 may also, in some examples, function as a private inter-business server storing, among others, employee work schedules or other data that may enable the central irrigation controller 12 or the mobile device 24 to make determinations about when, for example, but not limited to, an employee will be present on the grounds of the business (e.g., a work schedule). In some examples, the remote server 27 may be representative of, for example, a third-party or “outside” (e.g., not proprietary or inter-business) server via the network 28. In some examples, the remote server 27 may enable the central irrigation controller 12 or the mobile device 24 to obtain map or satellite information and/or imagery, weather data such as past, present, or forecasted rainfall, humidity, or other weather-related information to automatically adjust or vary an irrigation schedule, or present a text based or graphical suggestion or alert.

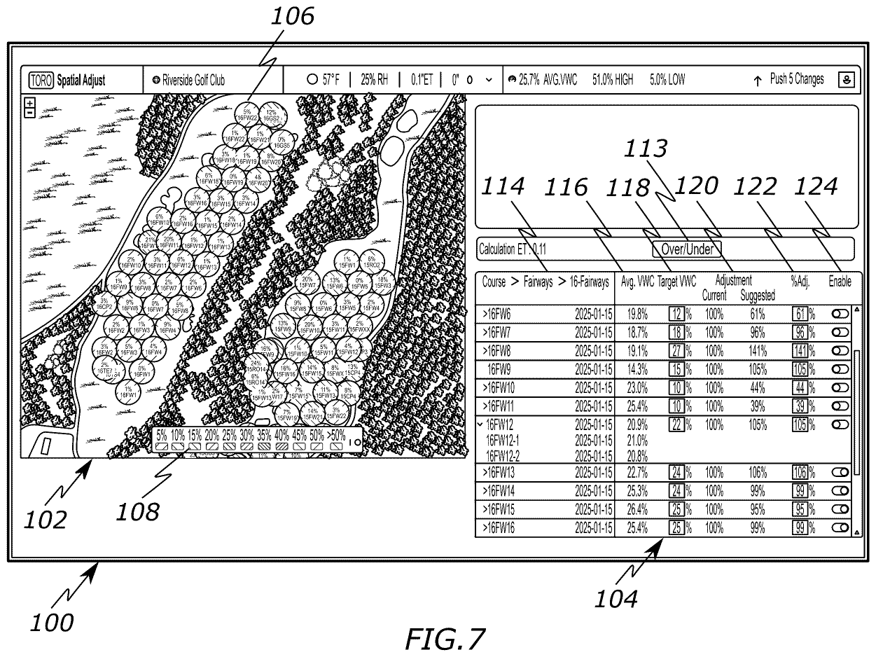

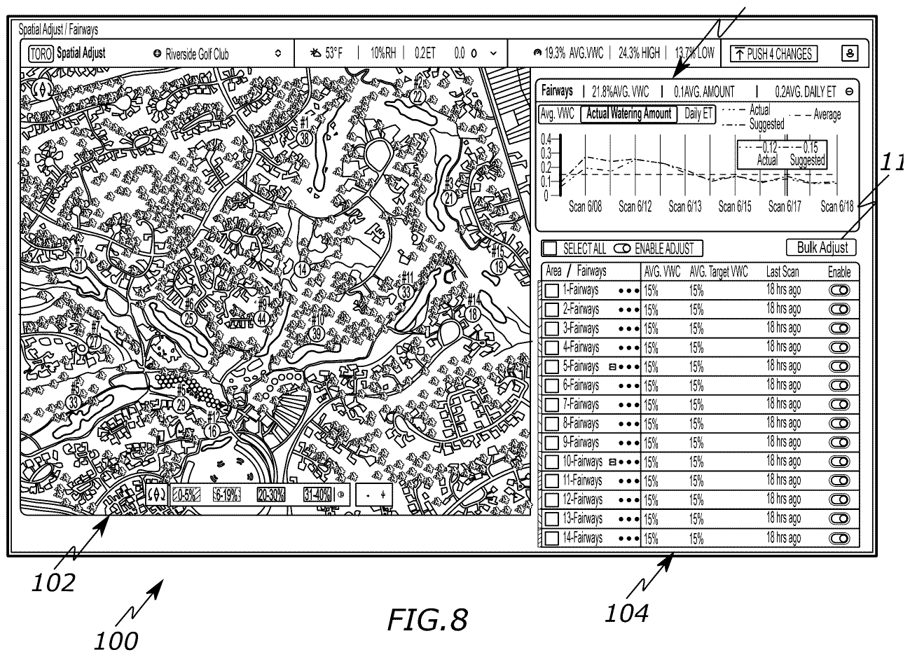

In some examples, the irrigation system 20 may further include any of the components described with respect to FIGS. 7-8 of U.S. Pat. No. 10,743,482 incorporated by reference herein to enable the central irrigation controller 12 to obtain water use or flow data from a water pump station and display the data to on a graphical user interface. This may allow a user to, or the central irrigation controller 12 to automatically, create an electronic irrigation note (e.g., information such as text and/or image(s) associated with at least one of one or more identifiers 103) in response to, or at least partially based thereon. In some examples, the irrigation system 20 may further include any of the components described with respect to FIGS. 7-8 of U.S. Pat. No. 10,743,482 previously incorporated above, to enable the central irrigation controller 12 to obtain soil moisture data from a plurality of moisture or soil sensors, to utilize to obtain soil moisture data and display the data to on graphical user interface.

In view of all the above, each of the central irrigation controller 12, the mobile 24, the sprinkler 16, and the satellite controller or gateway 14 may, in various examples or combinations, communicate with each other via the same or a combination of network protocols, and with other devices via the communication network 28, and may be configured to perform operational functions including, among others, data display and entry, data or signal processing, data or signal transmitting, and geospatial location.

In some examples, the irrigation system 20 may include one or more devices that collect soil measurement data measured from a plurality of locations at an irrigation site. The plurality of locations may include at least one location measured within a watering area of a sprinkler and possibly several locations measure within a watering are of a single sprinkler. In that respect, the irrigation system 20 may obtain soil measurement data from multiple locations within each sprinkler watering area of some or all of the sprinklers of the irrigation site.

Specific examples of the devices used to collect soil measurement data can be found in U.S. Pub. 20230403999, the contents of which are incorporated herein by reference. For example, a vehicle may move a mobile turf instrument apparatus that may include one or more soil sensors (e.g., ground penetrating probes, sensors spaced away from the ground, in-ground sensors, etc. ,) and a GPS system, thereby allowing geographical coordinates to be associated with soil measurement data measured and stored. The soil measurement data may include soil moisture, soil salinity, temperature (air or soil temperature), and soil compaction.

Once the soil measurement data and geographic coordinate data for each measurement is obtained for locations along the irrigation site, this data may be stored and optionally processed for use by the central irrigation controller 12. For example, this data may be stored locally in the memory 32 (e.g., hard drive) of the central irrigation controller 12 or may be stored in a remote storage device 26 that is accessible by accessing a remote server 27 via a network 28 (e.g., LAN or WAN). Such measurements may be periodically repeated over time across the irrigation site.

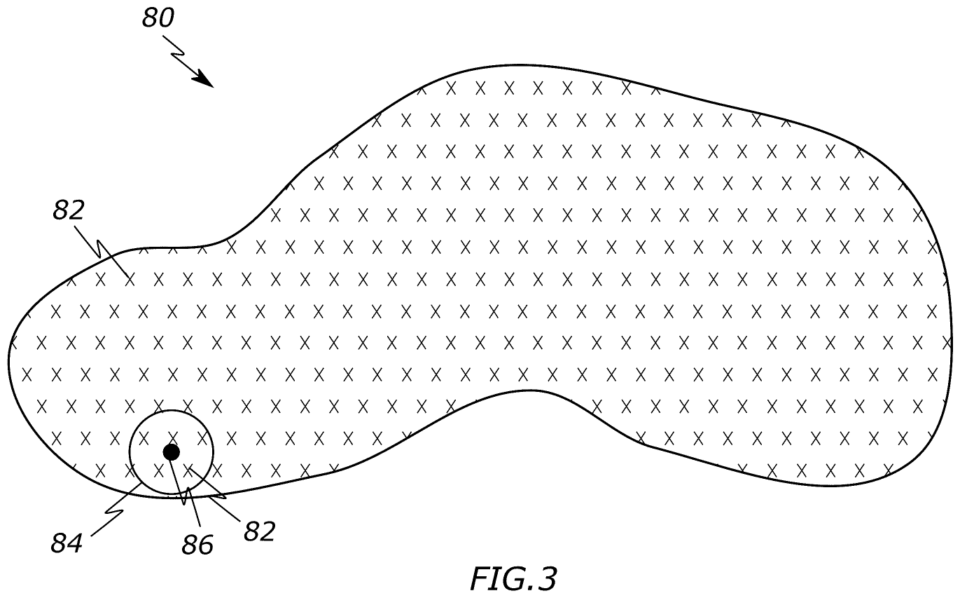

FIG. 3 illustrates an example schematic view of an irrigation site 80 that includes geographic coordinate locations 82 where soil measurement data has been measured. The geographic coordinate location of a sprinkler 86 and a geographic watering area 84 (e.g., arc, circle, or perimeter) of the sprinkler 86 are also illustrated. The geographic coordinate location of the sprinkler 86 may be determined and entered into the software of the central irrigation controller 12. Similarly, the geographic watering area 84 may be known based on different factors (e.g., sprinkler type, nozzle type, and/or water pressure) or may be measured for inputting into the software of the central irrigation controller 12. While only one sprinkler 86 and geographic watering area 84 are illustrated in FIG. 3, a typical irrigation site 80 may have many sprinklers that each have their own watering areas.

Depending on the locations of each of the geographic coordinate locations 82 of soil measurement data, the geographic watering area 84 may include one or a plurality of geographic coordinate locations 82 associated with soil measurement data. Since some sprinklers 86 have a relatively large geographic watering area 84, it is possible and even likely that several geographic coordinate locations 82 associated with soil measurement data are present within the geographic watering area 84.

Even with a plurality of a plurality of geographic coordinate locations 82 along an entire irrigation site 80, it can be difficult for a user to know how to adjust an irrigation schedule appropriately. The present specification provides interfaces and techniques for better processing, displaying, and utilizing this type of data.

As discussed elsewhere in this specification, several irrigation software interfaces are disclosed that illustrate a single representative soil measurement data value (e.g., soil moisture) that is representative of an entire geographic watering area 84 of a sprinkler 86 and that further allows a user to adjust irrigation controls for only a single sprinkler 86 based on that single soil measurement data value. In that respect, it may be helpful to process or combine the soil measurement data of each geographic coordinate locations 82 within each geographic watering area 84 to produce a single representative soil measurement data value. This concept may also be referred to as a representative value, a representative measurement value, a calculated representative value, a representative soil moisture value, or similar variations for brevity.

In some examples, all soil measurement data values from different geographic coordinate locations 82 within a geographic watering area 84 are averaged together. In a specific example, if several soil moisture measurements are made at geographic coordinate locations 82 within a geographic watering area 84 of a sprinkler 86, those soil moisture values are averaged together to provide a single measurement value for a geographic watering area 84. This process may be performed for all watering areas of all sprinklers or only for some sprinklers.

In other examples, all soil measurement data values at geographic coordinate locations 82 within a geographic watering area 84 may be combined together via a more complicated formula or algorithm than averaging, such as a formula that takes into consideration multiple types of soil measurement data. For example, soil moisture values may be weighted before averaging based on salinity, temperature, or turf type.

An example method may include obtaining soil measurement data values at a plurality of geographic coordinate locations 82, processing the soil measurement data values within a single geographic watering area 84 of a sprinkler 86 by calculating a single value representative of the entire geographic watering area 84 for a soil measurement data type (e.g., averaged soil moisture), storing the single value representative of the entire geographic watering area 84 for a soil measurement data type, and then optionally repeating this process for additional types of soil measurement data types and/or additional watering areas 84 of additional sprinklers 86 at an irrigation site 80.

The representative soil moisture values discussed in this specification may be calculated using any suitable mathematical technique, including averaging, weighted averaging, interpolation, or other aggregation algorithms. In some examples, the representative soil moisture value is a software-generated value derived from multiple spatially distinct measurements and does not correspond to a single physical sensor reading.

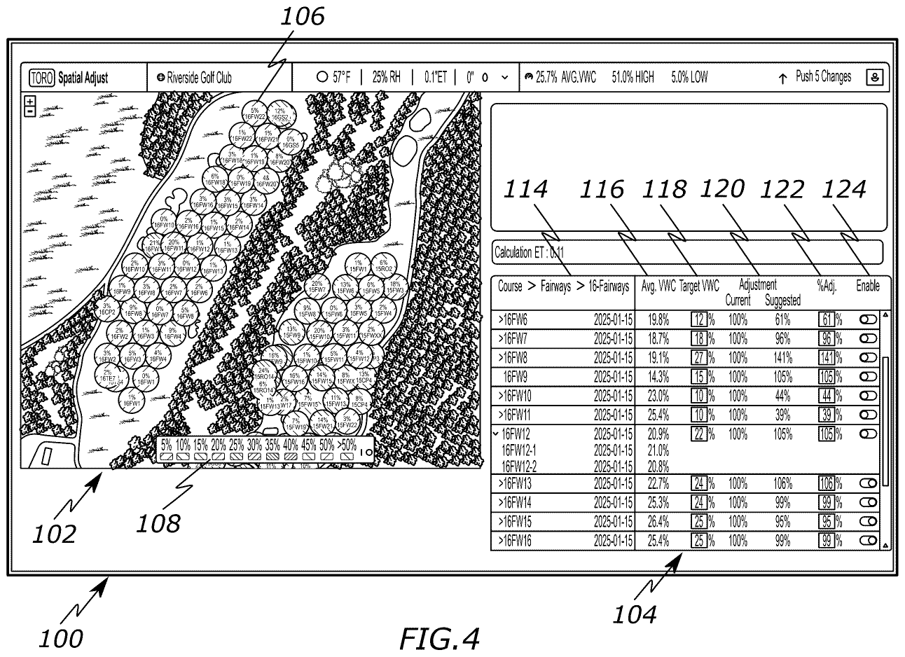

FIG. 4 illustrates a central irrigation controller interface 100 of irrigation software that utilizes the calculated single value representative of the entire geographic watering area 84 (e.g., averaged soil moisture values). The central irrigation controller interface 100 may include a geographic map area 102 of part or all of an irrigation site (e.g., irrigation site 80) and a data and control area 104 that may provide data and/or irrigation adjustments for individual sprinklers 86. The central irrigation controller interface 100 reflects results of controller-executed calculations and enables display and application of those results to perform irrigation control.

The geographic map area 102 may illustrate a photograph or map of all of or part of the irrigation site (e.g., irrigation site 80). The geographic map area 102 may display watering area elements 106 that each correspond to the geographic perimeter or area of the geographic watering area 84 of a sprinkler 86 (e.g., as seen in FIG. 3) in both location and size on the photo/map. In some examples, these watering area elements 106 are circular in shape to illustrate the watering radius entirely around a sprinkler, but may be other shapes, such as arc shapes, as well.

The irrigation software may change or display each of the watering area elements 106 in a manner that indicates or communicates individual a soil moisture metric for each sprinkler 86. In some examples, the soil moisture metric is a representative soil moisture value calculated from a plurality of soil moisture measurements at geographic coordinate locations located within the respective geographical watering area of only the corresponding one of the sprinklers 86. In some examples, this indication is a numeric value of the representative soil moisture value or is a difference between a target soil moisture value for a single sprinkler and a single representative value of the single sprinkler (delta soil moisture value). In other examples, the indication is a change of color corresponding to either the representative soil moisture value or the delta soil moisture value. This may allow a user of the irrigation software to better understand soil conditions within each geographic watering area 84 of each sprinkler 86. This may also allow the user to better adjust irrigation individually for each sprinkler to achieve improved watering. Previous irrigation software, and especially central irrigation software, lack these features because of the impracticality of placing multiple soil sensors within each geographic watering area 84 of each sprinkler 86. In the case of large irrigation sites, such as golf courses, installing multiple soil sensors in each geographic watering area 84 of each sprinkler 86 may add significant expense (e.g., millions of dollars in costs) and may well be impossible to install or to relay data back to a central controller.

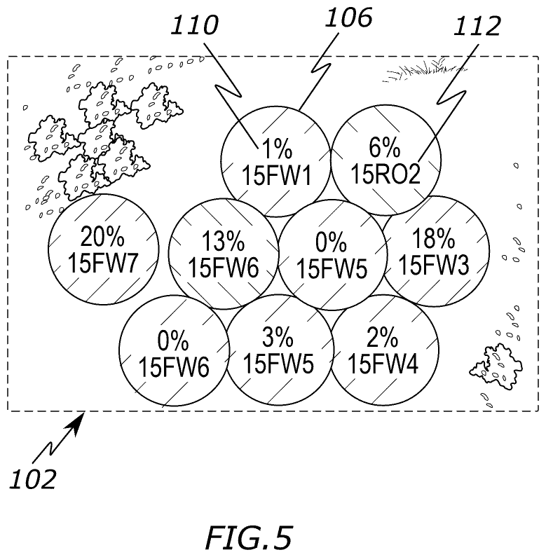

In one example, each of the watering area elements 106 may display a numerical value within it of that representative single value (e.g., an averaged soil moisture value). Specifically, as seen in FIG. 4 and the magnified view of the geographic map area 102 in FIG. 5, each of the watering area elements 106 display a numerical value 110 which, in the present example, is a representative value of moisture content of the soil within the actual geographic watering area 84 (e.g., an average volumetric water content averaged from soil measurements at several geographic coordinate locations 82 within the geographic watering area 84). Again, each numerical value 110 may be obtained by performing a calculation, such as averaging or weighted averaging, of soil measurement values at several geographic coordinate locations 82 within a geographic watering area 84 of a sprinkler 86. Additionally or alternatively, each numerical value 110 may display a difference between a target soil moisture value for a single sprinkler and a single representative value of soil moisture data (e.g., a soil moisture delta value between the two).

Optionally, each watering area element 106 may also include a sprinkler identification label 112 used by the irrigation software to identify a sprinkler 86. Representative values other than soil moisture may additionally or alternatively be displayed in the watering area elements 106, such as an average salinity or temperature averaged from soil measurements at several geographic coordinate locations 82 within the geographic watering area 84.

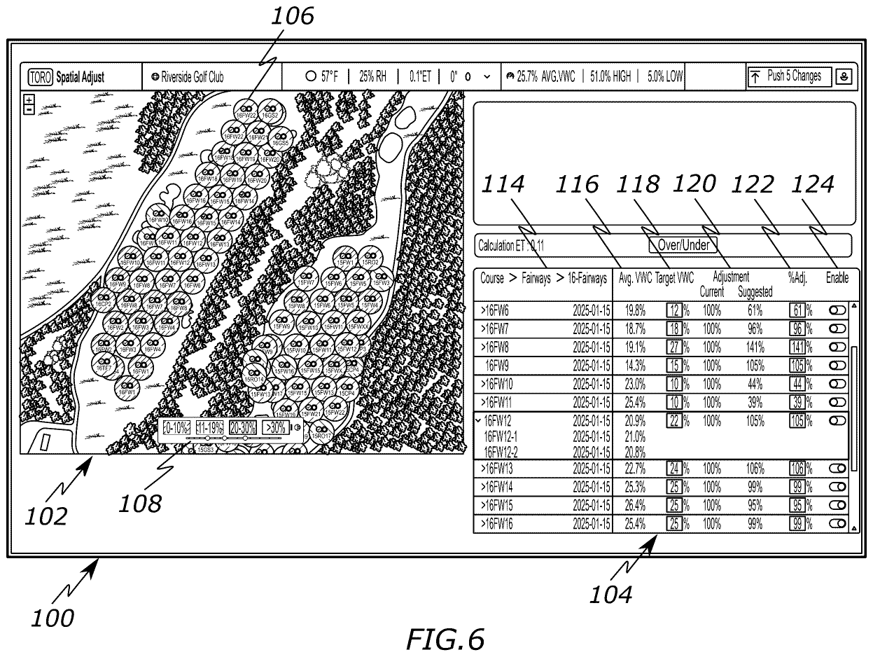

Each watering area elements 106 may also or alternatively be displayed as different colors that represent a calculated single value representative of the entire geographic watering area 84. In FIGS. 4 and 5, different directions of shading in each watering area elements 106 represent different colors in the geographic map area 102 of the irrigation software. A color key element 108, as seen best in FIG. 4, may communicate values or different ranges of values that each color represents. In the present example, each color corresponds to a specific value of soil moisture for each watering area elements 106 (e.g., volumetric water content or VWC). FIG. 6 illustrates the central irrigation controller interface 100 in with each watering area elements 106 only display colors that correspond to specific values or ranges of a representative value (e.g., soil moisture) as specified in the color key element 108. Additionally or alternatively, each of the watering area elements 106 may display a color corresponding to a difference between a target soil moisture value for that single sprinkler and a single representative value of soil moisture data for that sprinkler (e.g., a soil moisture delta value between the two).

In the present example of FIG. 4, the data and control area 104 may provide an area where each calculated single value representative of the entire geographic watering area 84 is shown near an identification for each sprinkler 86. The data and control area 104 is illustrated as a table, but other formats may also be possible.

In some examples, a sprinkler identification column 114 includes a list of identification labels for a plurality of sprinklers 86 controlled by the central irrigation controller interface 100. A representative value column 116 of the data and control area 104 may display a value that each corresponds to an identification label from sprinkler identification column 114 and which was obtained by performing a calculation, such as averaging or weighted averaging, of soil measurement values at several geographic coordinate locations 82 within a geographic watering area 84 of a sprinkler 86. This allows a user to quickly see the single representative value for each sprinkler label and therefore each sprinkler 86.

The data and control area 104 may also include several more columns that allow a user to easily adjust irrigation for an individual sprinkler 86 based on a single value representative of soil measurement data of an entire geographic watering area 84 of a sprinkler 86. In the present example, the data and control area 104 allows a user to view a difference between a target soil moisture value for a single sprinkler and a single representative value of soil moisture data (e.g., a soil moisture delta value between the two).

In one example method, the controller or software obtains soil moisture measurements at a plurality of geographic coordinate locations within a watering area of an individual sprinkler and computes a representative soil moisture value for that watering area by aggregating the measurements (e.g., by averaging or weighted averaging). The controller then accesses a user-specified target soil moisture value associated with that sprinkler and calculates a delta soil moisture value as a difference between the representative value and the target value; in some implementations the difference is expressed as a percentage relative to the target. The delta soil moisture value is stored and displayed in the user interface, including within map-based watering area elements and tabular views, and may drive suggested adjustments to irrigation parameters for that sprinkler. The interface can also update automatically when new soil measurements are received, recalculating representative values and the corresponding delta without user intervention, and optionally color-coding watering area elements based on the computed delta ranges.

Additionally, the data and control area 104 may calculate an adjustment (e.g., percentage adjustment) to the runtime of only that specific sprinkler and enable that adjustment. Specifically, the data and control area 104 may include a target value column 118 that allows a user to input a specific soil moisture target value for the geographic watering area 84 of a sprinkler 86. An adjustment column 120 may also be included that displays a current percentage adjustment value for each sprinkler and a suggested percentage adjustment value for each sprinkler (e.g., a difference between the representative value in the representative value column 116 and the target value from the target value column 118). A percentage adjustment column 122 may also be included that allows the software to automatically specify a value the percentage adjustment may be changed to and/or may allow the user to manually enter/adjust that value. Finally, an enable column 124 may include an input element (e.g., a toggle button) that activates the percentage adjustment value from the percentage adjustment column 122 to the irrigation schedule for only the corresponding sprinkler from the sprinkler identification column 114.

In one example method, the controller automatically calculates a percentage adjustment value for an individual sprinkler based on a representative soil moisture value and a user-specified target soil moisture value associated with that sprinkler. After determining the representative soil moisture value from multiple soil moisture measurements obtained within the watering area of the sprinkler, the controller compares the representative value to the target value and calculates a difference between the two. The controller then converts the difference into a percentage adjustment, which may represent a relative increase or decrease in a watering amount, runtime, or other irrigation parameter required to move the soil moisture level toward the target value. The calculated percentage adjustment may account for any existing adjustment value already applied to the sprinkler. The controller subsequently applies the calculated percentage adjustment automatically to modify the irrigation amount delivered by the sprinkler during one or more future irrigation cycles, thereby adjusting irrigation output without requiring manual entry of sprinkler-specific runtime values. The percentage adjustment and resulting irrigation change may be updated automatically as new soil moisture data or updated target values are received.

In one example method, the controller receives new soil measurement data associated with one or more geographic locations at the irrigation site and automatically determines whether the new data corresponds to a watering area of one or more sprinklers. In response, the controller recalculates the representative soil moisture value for each affected sprinkler and updates any corresponding delta soil moisture values and percentage adjustment values. The controller automatically refreshes one or more user interfaces to display the updated values, including map-based views, tabular views, or graphical trend views, without requiring manual user input. This allows the irrigation system to reflect current soil conditions in near real time.

In some examples, such as seen in FIG. 8, the control area 104 may also include a “last scan” column that displays a date of the last soil measurement readings (and optionally representative calculation) for each sprinkler. This may help the user better understand how relevant any data in the data and control area 104 may be.

In this respect, the irrigation software provides a calculated percentage adjustment change to a specific sprinkler listed in the sprinkler identification column 114 by determining a difference between entries of the representative value column 116 and target value column 118, converting that difference to a percentage value, and then applying that change to the entry in the adjustment column 120 and percentage adjustment column 122 (accounting for any existing percentage adjustments applied to the sprinkler). Again, this allows the user to quickly and easily adjust the irrigation of a single sprinkler 86 to a desired level.

In the central irrigation controller interface 100 of FIG. 7, each watering area element 106 may display a numerical delta soil moisture value, which may be based on the user-specified target soil moisture level (e.g., VWC) and the measured, representative soil moisture value for a specific sprinkler 86. For example, a numerical percentage may be displayed that indicates what percentage the measured, representative soil moisture value differs from the user-specified target soil moisture level. A non-percentage delta soil moisture value may additionally or alternatively be displayed within the watering area elements 106.

Additionally or alternatively, the color of each watering area elements 106 may be changed to correspond to this delta soil moisture value and optionally explained in the color key element 108. In the present example of FIG. 7 and as seen in the color key element 108, different colors are mostly assigned in 5% ranges. However, any range, both positive and negative, is possible (e.g., any range between 1-50 percent). In one specific example, a range of- 5% to 5% may have a first color (e.g., green), a range of any value less than-5% may have a second color (e.g., yellow), and a range of any value more than 5% may have a third color (e.g., red or purple).

By showing the delta soil moisture value and/or color corresponding to the delta soil moisture value in each watering area elements 106, the user may quickly determine which sprinkler 86 requires adjustment to its irrigation schedule to achieve a desired soil moisture level.

In one example method, the controller assigns a visual attribute to each watering area element based on a corresponding representative soil moisture value or delta soil moisture value. The controller maps the value to a predefined range and assigns a corresponding color, shading pattern, or other graphical indicator. The watering area elements are then rendered on a geographic map such that visual differences between elements provide an at-a-glance indication of relative soil moisture conditions across the irrigation site.

As seen in FIG. 8, the central irrigation controller interface 100 may also display a graph or chart area 130 that may display a graph or chart of either representative data values (e.g., representative soil moisture values) or delta soil moisture values (e.g., difference between a user-specified target value and the representative data value). The graph or chart may display data over a plurality of days, weeks, months, or years, for only a single sprinkler 86 and its geographic watering area 84. Again, this may allow a user of the irrigation software to better understand the individual area of the geographic watering area 84 of a sprinkler 86 and thereby better adjust irrigation to desired levels.

In one example method, the controller stores representative soil moisture values, delta soil moisture values, or percentage adjustment values for a sprinkler over time. The controller displays the stored values in a graphical format showing changes across multiple dates, enabling a user to review historical irrigation performance and soil moisture trends for an individual sprinkler or watering area.

In response to receipt of new soil measurement data, the controller recalculates representative values and updates the central irrigation controller interface 100 (e.g., geographic map area 102 and data and control area 104) without user intervention.

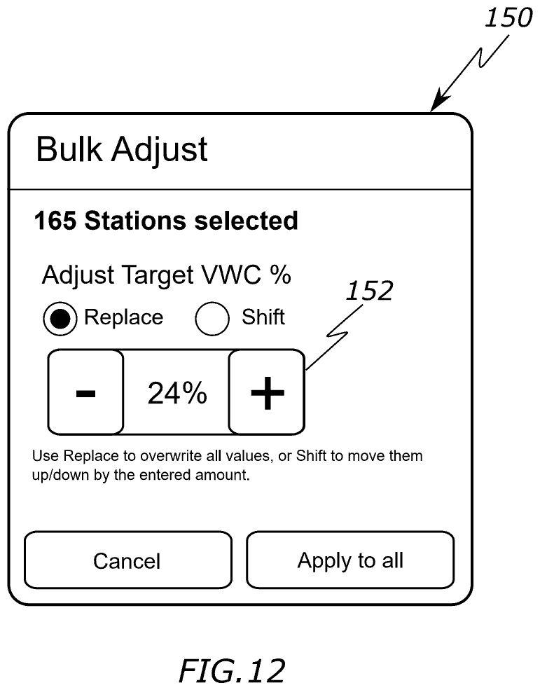

In some cases, it may be desirable to manually adjust the target soil moisture value delivered from several sprinklers 16 at the same time. Referring to FIG. 8, this may be achieved, in one example, by selecting a plurality of sprinklers from the data and control area 104 (e.g., non-contiguous or adjacent sprinkler) and then selecting a bulk adjust interface element 111. Note that selection of the sprinkler from the data and control area 104 may be based on filters, map selection, or table selection. The bulk adjust interface element 111 may then bring up a new bulk adjust interface 150, seen in FIG. 12, which may include an input element 152 which allows the user to input or adjust a target soil moisture value that should be increased or decreased from the previously selected sprinklers 16. The input element 152 may be used to replace or shift (e.g., increase/decrease) the existing target VWC percentage, which then applies that value accordingly to the previously selected sprinklers 16. In some cases, this may help the user to fine tune watering adjustments to best delivery an appropriate amount of water. For example, in the summer a user may want to initially set all of the sprinklers at the irrigation site to a target soil moisture content of 20% with the “replace” setting of the input element 152. Over time, the user may adjust those target soil moisture content values individually for each sprinkler to something different. Some may still be at 20%, some at 18%, some are 22%, etc. In the fall, the user may want to globally adjust those targets down 2-3% to account for cooler temperatures but still keep the relative differences in place. The “shift” setting of the input element 152 will globally shift the target soil moisture values of the sprinklers accordingly.

In one example method, the controller receives user input selecting a plurality of sprinklers for bulk modification. The selection may include non-contiguous sprinklers and may be performed via a map-based interface, a tabular interface, or a filtered list of sprinklers. The controller then receives a bulk adjustment input specifying a common adjustment value replacing or shifting existing target soil moisture values. In response, the controller automatically applies the common adjustment value to a target soil moisture value of each selected sprinkler accordingly (replace or shift), such as a target soil moisture value, thereby modifying irrigation operation for all selected sprinklers in a coordinated manner.

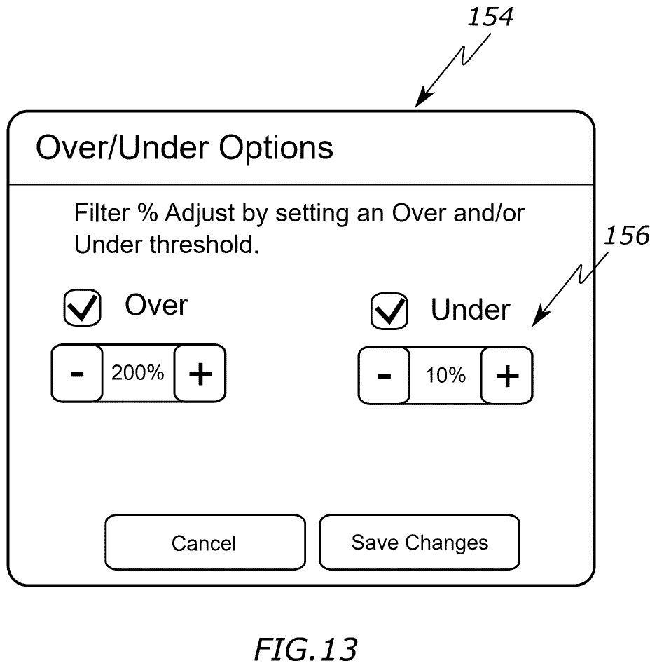

It may also be helpful to filter the sprinkler entries in the control area 104 and/or geographic map area 102 (or other areas) to only those that have a measured average VWC greater than or less than the target VWC to quickly review sprinklers that need adjustment. In one example seen in FIG. 7, a filter interface element 113 may be included on the central irrigation controller interface 100 to filter for only sprinklers that have a measured average VWC greater than or less than the target VWC. When the filter interface element 113 is actuated, a filter interface 154 may be displayed, as seen in FIG. 13. The filter interface 154 may include input elements 156 that allow a user to selectively adjust the filtered results to include values over a specified percentage or moisture value, under a specified percentage or moisture value, or both over and under specified values. Saving these filtered parameters may revert the user back to the prior interface (e.g., the FIG. 7 interface, where the data and control area 104 and/or the geographic map area 102 displays only sprinklers with a measured average VWC that meets the filter criteria specified by the user.

In one example method, the controller determines, for each sprinkler, a measurement value associated with a watering area and compares the measurement value to a reference value, such as a user-specified target soil moisture value. The controller receives a filter criterion specifying whether to identify sprinklers having measurement values above the reference value, below the reference value, or within a specified range. In response, the controller selectively displays or identifies only those sprinklers satisfying the filter criterion within the user interface and optionally enables further actions, including selection of the identified sprinklers for bulk adjustment or review.

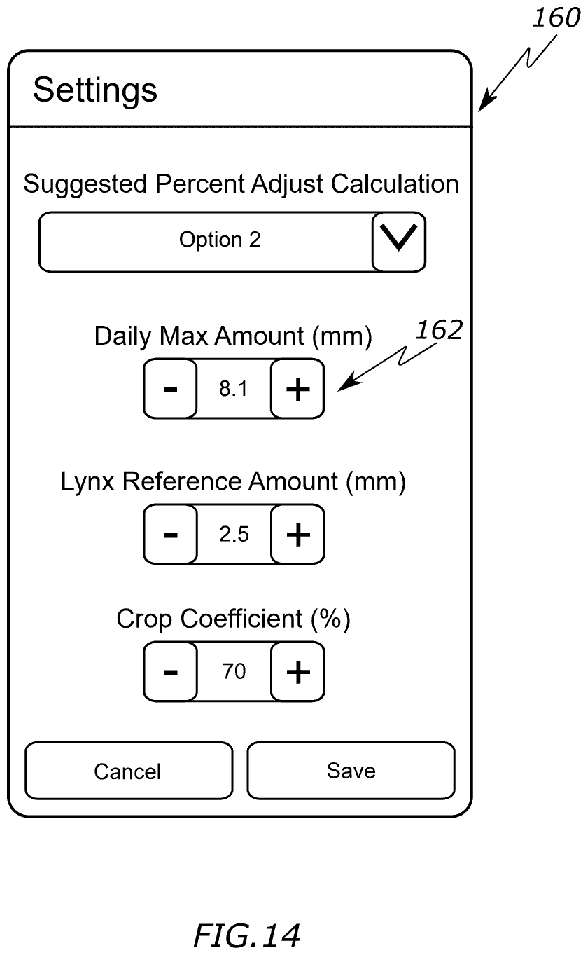

In some cases, it may be helpful to adjust certain crop coefficient and evapotranspiration (ET) settings used for calculating how much water should be irrigated to best achieve a target soil moisture value or VWC. In one example, the central irrigation controller interface 100 may include a crop coefficient interface 160, as seen in FIG. 14, which includes interface elements 162 which allow a user to modify several adjustments, including different percentage adjustment calculation formulas, a daily maximum amount of water, a reference amount of water, and a crop coefficient percentage for use with a reference ET value from a provider or local weather station. Hence, the user may easily modify reference ET values corresponding to their specific cool season or warm season turfgrass variety.

In one example method, the controller receives user input specifying one or more crop coefficient parameters via a configuration interface. The controller applies the crop coefficient parameters to modify a calculation used to determine irrigation parameters, including adjusting a target soil moisture value, a reference evapotranspiration value, or a percentage adjustment value. The modified irrigation parameters are then used to automatically adjust irrigation amounts for one or more sprinklers during subsequent irrigation cycles, allowing irrigation behavior to adapt to turf type, seasonal conditions, or environmental changes.

Any of the interfaces described in this specification (e.g., geographic map area 102 and data and control area 104) may be toggled to coexist or co-display at the same time.

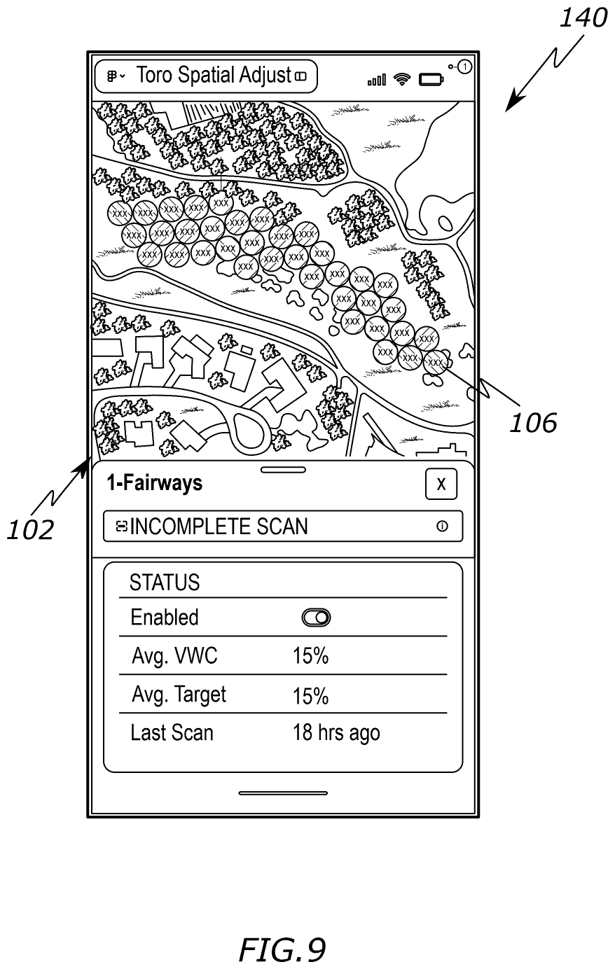

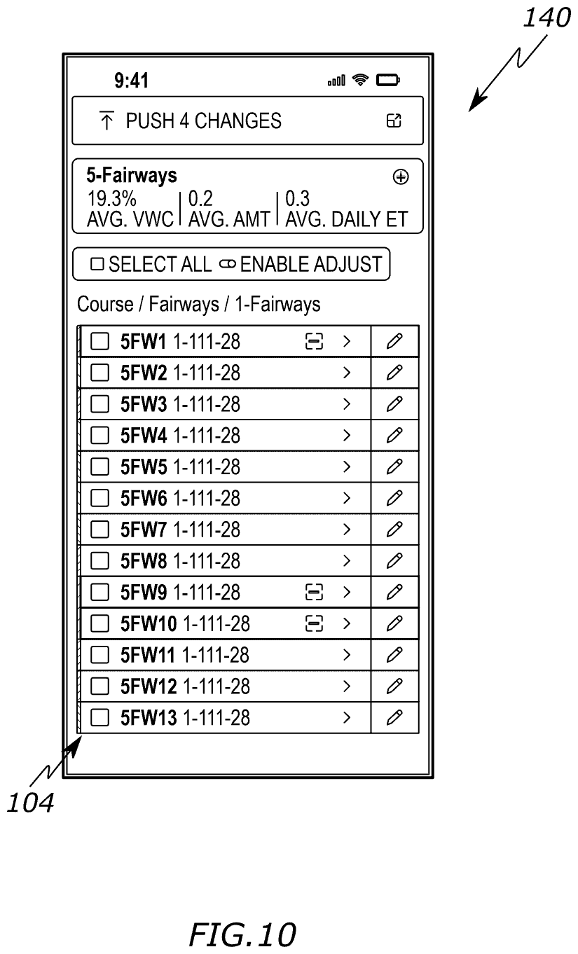

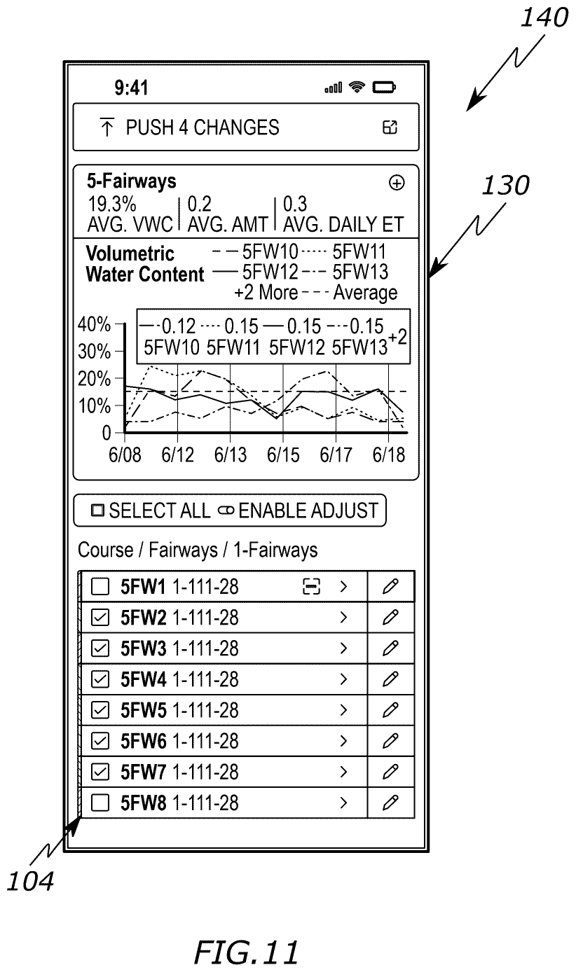

Any of the previously described software interfaces may also or alternatively be displayed on software of a mobile device 24. For example, FIG. 9 illustrates a mobile irrigation controller interface 140 having a geographic map area 102 with features as previously described, such as watering area elements 106. FIG. 10 illustrates a mobile irrigation controller interface 140 with a data and control area 104 as previously described. FIG. 11 illustrates a data and control area 104 with a data and control area 104 and graph or chart area 130 as previously described. Each of these views and areas of the mobile irrigation controller interface 140 may be particularly helpful to allow a user to physically approach a sprinkler 86 and geographic watering area 84 at an irrigation site 80, view representative soil measurement data (e.g., single representative soil moisture value or soil moisture delta value for the geographic watering area 84), view the condition of the turf within the geographic watering area 84, and then adjust irrigation accordingly for only that specific sprinkler 86 based at least in part on those factors. This may allow the user to better fine tune irrigation for an irrigation site 80.

The operations described herein are performed by one or more processors executing stored instructions to process sensor-derived data, generate calculated irrigation control values, and automatically control physical irrigation hardware. The described techniques are not limited to organizing or displaying information, but instead enable automated modification of irrigation behavior in response to measured soil conditions, thereby improving operation of irrigation systems.

What is claimed is:

1. A system for watering an irrigation site, the system comprising:
a central irrigation controller comprising a processing device and a memory device storing computer readable instructions executable by the processing device to cause the processing device to:
control a plurality of irrigation sprinklers;
display an interface comprising:
a graphical geographic map representing the irrigation site; and, watering area elements that each correspond to a respective geographical watering area of a corresponding one of a plurality of irrigation sprinklers located at the irrigation site;
wherein each of the watering area elements indicate a soil moisture metric based on a representative soil moisture value calculated from a plurality of soil moisture measurements at geographic coordinate locations located within the respective geographical watering area of only the corresponding one of the plurality of irrigation sprinklers.

2. The system of claim 1, wherein the watering area elements indicate the soil moisture metric by displaying a numeric value in one or more of the watering area elements, by changing or displaying a color that corresponds to the soil moisture metric, or by both displaying a numeric value that corresponds to the soil moisture metric and changing or displaying a color that corresponds to the soil moisture metric.

3. The system of claim 1, wherein the soil moisture metric is displayed in numeric form.

4. The system of claim 3, wherein the numeric form is the representative soil moisture value.

5. The system of claim 4, wherein the representative soil moisture value is displayed as an average volumetric water content.

6. The system of claim 3, wherein the numeric form is a delta soil moisture value calculated by a difference between a target soil moisture value for a single sprinkler and a single representative value of the single sprinkler.

7. The system of claim 1, wherein the representative soil moisture value is calculated by generating an average or weighted average of the plurality of soil moisture measurements.

8. The system of claim 1, wherein the watering area elements are circular in shape.

9. The system of claim 1, wherein the watering area elements indicate the soil moisture metric by changing or displaying a color that corresponds to the soil moisture metric.

10. The system of claim 9, wherein soil moisture metric is the representative soil moisture value.

11. The system of claim 9, wherein the soil moisture metric is a delta soil moisture value calculated by a difference between a target soil moisture value for a single sprinkler and a single representative value of the single sprinkler.

12. The system of claim 6, wherein the watering area elements display numerical values of the representative soil moisture value.

13. The system of claim 1, wherein the interface further comprises a table displaying a plurality of sprinkler identifiers that each correspond to one of the plurality of sprinklers and the soil moisture metric of each of the plurality of sprinklers.

14. The system of claim 13, wherein the soil moisture metric is the representative soil moisture value or a delta soil moisture value calculated by a difference between a target soil moisture value for a single sprinkler and the representative value of the corresponding sprinkler.

15. The system of claim 13, wherein the table further displays a suggested adjustment value for each of the each of the sprinkler identifiers, wherein the suggested adjustment value is calculated by determining a difference between the representative soil moisture value and a user-defined target value.

16. The system of claim 1, wherein the interface further comprises a graph or chart area displaying plurality of the representative soil moisture values for one of the plurality of irrigation sprinklers from different dates.

17. A method for watering an irrigation site, comprising:
executing irrigation software on a central irrigation controller configured to control a plurality of irrigation sprinklers;
displaying an interface of the irrigation software with the central irrigation controller, the interface comprising:
a graphical geographic map representing the irrigation site; and,
watering area elements that each correspond to a respective geographical watering area of a corresponding one of a plurality of irrigation sprinklers located at the irrigation site;
wherein each of the watering area elements indicate a soil moisture metric based on a representative soil moisture value calculated from a plurality of soil moisture measurements at geographic coordinate locations located within the respective geographical watering area of only the corresponding one of the plurality of irrigation sprinklers.

18. The method of claim 17, wherein the watering area elements indicate the soil moisture metric by displaying a numeric value in one or more of the watering area elements, by changing or displaying a color that corresponds to the soil moisture metric, or by both displaying a numeric value that corresponds to the soil moisture metric and changing or displaying a color that corresponds to the soil moisture metric.

19. The method of claim 17, wherein the representative soil moisture value is calculated by generating an average or weighted average of the plurality of soil moisture measurements.

20. Irrigation software stored on a non-transitory machine-readable medium, the irrigation software comprising computer-executable instructions which, when executed by a processing device of a central irrigation controller, cause the processing device to:
control a plurality of irrigation sprinklers;
display an interface comprising a graphical geographic map representing the irrigation site and watering area elements that each correspond to a respective geographical watering area of a corresponding one of a plurality of irrigation sprinklers located at an irrigation site;
compute for each of the plurality of irrigation sprinklers, a soil moisture metric based on a representative soil moisture value calculated from a plurality of soil moisture measurements at geographic coordinate locations located within the respective geographical watering area of only the corresponding one of the plurality of irrigation sprinklers; and,
cause each of the watering area elements to indicate the soil moisture metric associated with the corresponding irrigation sprinkler.
